(19) United States
(12) Patent Application Publication
(10) Pub. No.: US 2011/0047766 A1
(43) Pub. Date: Mar. 3, 2011

(54) PRE-CUT CLEAR POLYOLEFIN TAPE FOR CORPSE WOUNDS, AND METHODS OF FABRICATING AND UTILIZING SAME

(76) Inventors: SCOTT McAULAY, Fullerton, CA (US); Christopher S. Autterson, Novi, MI (US)

(21) Appl. No.: 12/856,201

(22) Filed: Aug. 13, 2010

Related U.S. Application Data
(60) Provisional application No. 61/238,234, filed on Aug. 31, 2009.

(51) Int. Cl. A01N 1/00; A61G 17/00

(52) U.S. Cl. 27/21.1

(57) ABSTRACT

A tape product and method of preparing a corpse for embalming or viewing by closing an open wound on the corpse to form a wound slit, applying to the wound slit a pre-cut clear polyolefin adhesive tape patch, and, when desired, blending the patch with skin color. The product is a pre-cut clear tape member to cover, close and seal a wound or scar on a corpse and essentially to replace skin on the corpse for viewing or embalming purposes, and comes in roll form or flat form with or without a release liner.

### CROSS-REFERENCE TO RELATED APPLICATIONS

The present patent application is a continuation-in-part of, is based on, and claims priority from U.S. Patent Application 61/238,234 filed Aug. 31, 2009.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a novel and unique pre-cut clear polyolefin tape for corpse wounds, and methods of fabricating and utilizing same.

More particularly, the present invention relates to novel and unique pre-cut or roll form clear polyolefin tape to be used as a corpse wound closure and sealer, and methods of fabricating and utilizing same.

Many corpses are of very elderly persons having paper thin skin that tears easily. There is presently no way to cover wounds and scars on such corpses except with ugly bandages or plastic looking sealant spread all over the wound.

It is a desideratum of the present invention to avoid the animadversions of conventional and present devices, and at the same time to provide a very convenient and easy to use pre-cut clear polyolefin tape to be used as a corpse wound closure and sealer, and methods of fabricating and utilizing same.

### SUMMARY OF THE INVENTION

The present invention provides a tape product for a corpse, comprising a pre-cut clear tape member to cover, close and seal a wound or scar on a corpse and essentially to replace skin on the corpse for viewing or embalming purposes.

The present invention also provides a method of preparing a corpse for embalming or viewing, comprising the steps of: closing an open wound on the corpse to form a wound slit; applying to said wound slit a pre-cut clear polyolefin adhesive tape patch; and, if desired, blending said pre-cut clear polyolefin adhesive tape patch with skin color.

It is a primary object of the present invention to provide a pre-cut clear polyolefin tape to be used as a corpse wound closure and sealer, and methods of fabricating and utilizing same.

Another object of the present invention to provide tape as described hereinabove, and wherein the tape is pre-cut in various convenient sizes and shapes.

A further object of the present invention to provide tape as described hereinabove, which minimizes time to prepare a corpse for showing or embalming, and avoids sewing needle injuries to the corpse preparer.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a top plan view of a plurality of pre-cut tape members cut on rolls with radius corners in accordance with a first embodiment of the present invention.

FIG. 2 illustrates a tape member supplied as individual pieces with a back slit liner.

FIG. 3 illustrates tape members supplied on sheets with a specific number of tape members on the sheet.

FIG. 4 illustrates an embodiment which is self-wound with no liner.

FIG. 5 shows another embodiment where the tape members are kiss-cut on a release liner in roll form.

FIG. 6 shows another embodiment where the tape members are in roll form having an back-score running in the web direction.

FIGS. 7-10 illustrate a sequence showing use of the tape members.

### DETAILED DESCRIPTION OF THE INVENTION

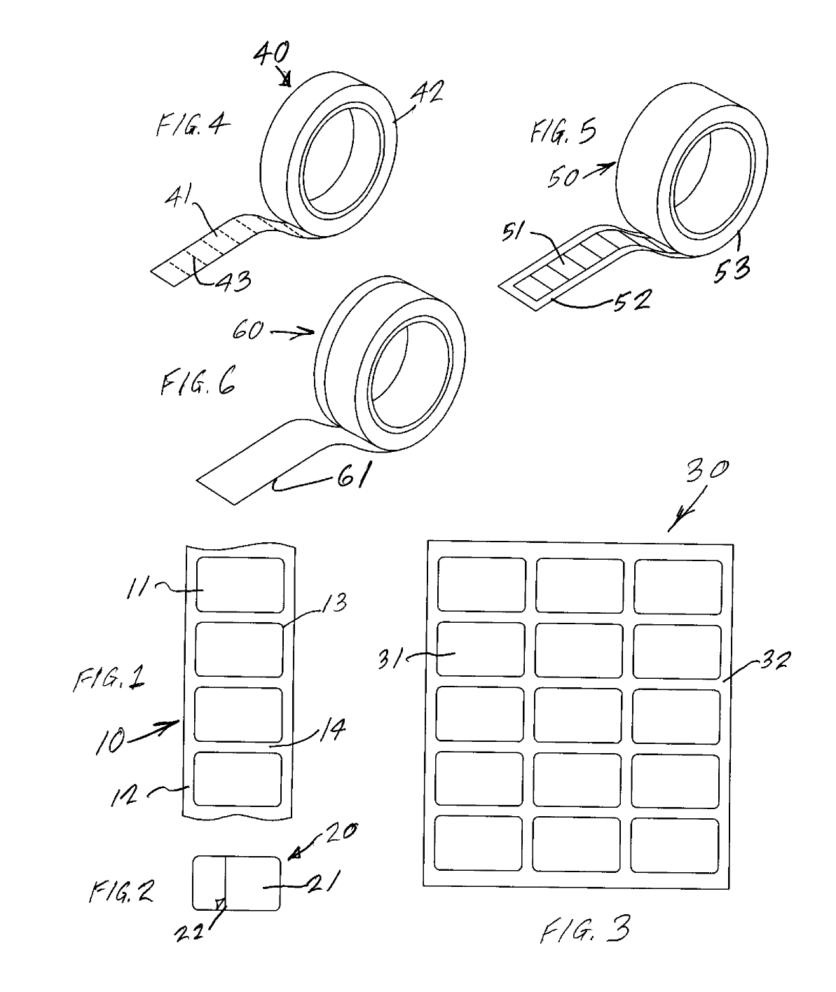

With reference to FIG. 1, there is shown a product 10 in accordance with a first embodiment of the invention.

Product 10 includes a plurality of pre-cut clear polyolefin tape members 11 arranged on a paper release liner 12.

Preferably, but not necessarily, the tape member 11 comprises a PE film about 3 to 6 mil thick, and an adhesive layer about 3-5 mil thick.

The tape members 11 can be made with radius corners 13, and in various shapes and sizes.

Spaces 14 are provided between adjacent members 11.

Product 10 can be made in roll form or on flat liners 12.

FIG. 2 illustrates product 20 wherein the tape members 21 are supplied as individual pieces with a back slit liner 22.

The parts are supplied as individual pieces with the back slit liner 22 which permits the user to remove only part of the liner at a time for ease of use.

FIG. 3 illustrates a product 30 having tape members 31 supplied on sheet 32 with a specific number of tape members 31 on the sheet 31.

FIG. 4 illustrates a product 40 wherein the tape members 41 are self-wound into a roll 42 with no liner.

The dotted lines 43 going across the web (side to side) are perforations. The product 40 is essentially a self-wound roll 42 of members 41 with perforations 41.

FIG. 5 shows a product 50 where the tape members 51 are kiss-cut on a release liner 52 in a roll form 53.

FIG. 6 shows a product 60 having an 80/20 back-score running in the web direction (or parallel to the liner 61. The back score is in the paper release liner 61 only. The back score on the back side liner (like a crack and peel bumper sticker) runs parallel with the liner edge. If it was a 4″ roll, then the back score would be approximately 0.80″ in from one edge. This allows the embalmer to cut a piece to length for custom fitting a particular incision or wound.

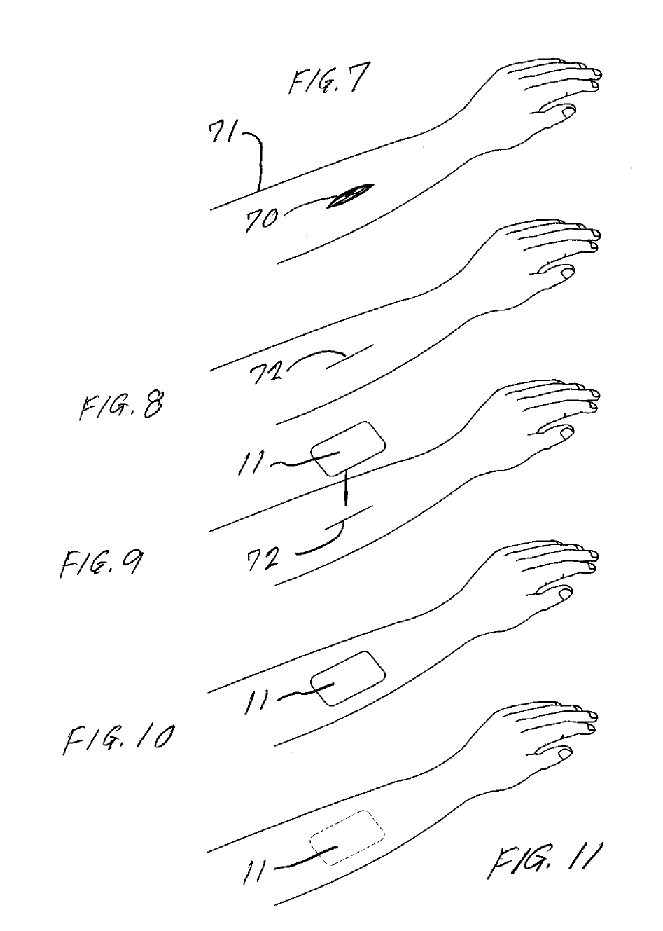

FIG. 7 shows an open wound 70 on the arm 71 of a corpse to be prepared for showing or embalming.

The embalmer can close open wound 70 to form a wound slit 72 as shown in FIG. 8.

FIG. 9 shows a tape member 11 (or 21, 31, 41, or 51) being applied to the wound slit 71.

FIG. 10 shows member 11 (or 21, 31, 41, or 51) adhesively applied to the wound slit 71.

FIG. 11 shows how the member 11 (or 21, 31, 41, or 51) looks after blending with skin color or having a cosmetic applied thereto.

The member 11 (or 21, 31, 41, or 51) may thus be a polyolefin adhesive tape patch, or a very similar patch which is thinner, having a different film, able to be tinted to multiple skin tones, and/or and possibly accept cosmetics. It is be used to cover wounds and essentially replace skin on the corpses for viewing purposes.

The parts may ultimately be supplied kiss cut on rolls; like labels/stickers on a roll. If they have square corners there will not be any spacing between them. If they have radius corners, they will have a matrix between parts. They could also be supplied on sheets of “X” amount of cut pieces.

Any and all such changes, modifications, variations and other uses and applications which do not depart from the spirit and scope of the present invention are therefore covered by and embraced within the patent claims set forth hereinbelow.

1. A tape product for a corpse, comprising:
a pre-cut clear tape member to cover, close and seal a wound or scar on a corpse and essentially to replace skin on the corpse for viewing or embalming purposes.

2. A tape product for a corpse according to claim 1, wherein:
said pre-cut clear tape member is provided with a back slit liner which permits the user to remove only part of said liner at a time for ease of use.

3. A tape product for a corpse according to claim 1, wherein:
said pre-cut clear tape member comprises a polyolefin adhesive tape patch.

4. A tape product for a corpse according to claim 2, wherein:
said pre-cut clear tape member comprises a polyolefin adhesive tape patch.

5. A tape product for a corpse according to claim 3, wherein:
said polyolefin adhesive tape patch comprises a polyolefin film which is approximately 3 to 6 mil thick, and an adhesive layer which is approximately 3 to 5 mil thick.

6. A tape product for a corpse according to claim 4, wherein:
said polyolefin adhesive tape patch comprises a polyolefin film which is approximately 3 to 6 mil thick, and an adhesive layer which is approximately 3 to 5 mil thick.

7. A tape product for a corpse according to claim 5, wherein:
said adhesive tape patch comprises a second film which is thinner than said polyolefin film and is fabricated from a different film that is able to be tinted to multiple skin tones.

8. A tape product for a corpse according to claim 6, wherein:
said adhesive tape patch comprises a second film which is thinner than said polyolefin film and is fabricated from a different film that is able to be tinted to multiple skin tones.

9. A tape product for a corpse according to claim 5, wherein:
said adhesive tape patch comprises a second film which is thinner than said polyolefin film and is fabricated from a different film that is able to accept cosmetics.

10. A tape product for a corpse according to claim 6, wherein:
said adhesive tape patch comprises a second film which is thinner than said polyolefin film and is fabricated from a different film that is able to accept cosmetics.

11. A tape product for a corpse according to claim 1, comprising:
a plurality of said pre-cut clear tape members.

12. A tape product for a corpse according to claim 11, wherein:
said pre-cut clear tape members are self-wound into a roll with no liner, and having a line of perforations between adjacent pre-cut clear tape members.

13. A tape product for a corpse according to claim 11, wherein:
said pre-cut clear tape members are arranged on a paper release liner in various shapes and sizes with spaces between adjacent pre-cut clear tape members; and
each said pre-cut clear tape member being provided with radius corners.

14. A tape product for a corpse according to claim 13, wherein:
said tape product is in roll form.

15. A tape product for a corpse according to claim 13, wherein:
said tape product is in on a flat liner.

16. A tape product for a corpse according to claim 13, wherein:
said pre-cut clear tape members are kiss-cut on said release liner in a roll form.

17. A tape product for a corpse according to claim 14, including:
an 80/20 back-scoring running in the web direction or parallel to the long dimension of said paper release liner;
said back-scoring is in only in said paper release liner; and
said back-scoring runs parallel to an edge of said paper release liner to allow the user to cut a piece to length for custom fitting a particular wound or incision on the corpse.

18. A tape product for a corpse according to claim 5, comprising:
a plurality of said pre-cut clear tape members

19. A method of preparing a corpse for embalming or viewing, comprising the steps of:
closing an open wound on the corpse to form a wound slit;
applying to said wound slit a pre-cut clear polyolefin adhesive tape patch; and
blending said pre-cut clear polyolefin adhesive tape patch with skin color.

20. A method of preparing a corpse for embalming or viewing according to claim 19, including the step of:
applying a cosmetic to said pre-cut clear polyolefin adhesive tape patch.
